(19) United States
(12) Patent Application Publication
(10) Pub. No.: US 2009/0103757 A1
(43) Pub. Date: Apr. 23, 2009

(54) SPEAKER BOX

(75) Inventors: Ta-Wei Chien, Hsinchu City (TW); Jung-Ya Hsieh, Taichung City (TW); Wei-Min Huang, Banciao City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/025,046

(22) Filed: Feb. 3, 2008

(30) Foreign Application Priority Data
Oct. 17, 2007 (TW) 96138850

(51) Int. Cl. H04R 1/02

(52) U.S. Cl. 381/345

(57) ABSTRACT

A speaker box is provided. The speaker box includes a flexible speaker and a housing. The flexible speaker includes an electret vibrating-film layer. The housing includes a first assembly part and a second assembly part partially connected with each other. A combining device is used to combine unconnected parts of the first assembly part and the second assembly part into a three-dimensional shape and a resonance space is formed therein. When the first assembly part and the second assembly part are not combined through the combining device, the first assembly part and the second assembly part are in flat shapes. The electret vibrating-film layer of the flexible speaker is at least located on an external side of the first assembly part or the second assembly part, or on external sides of the first assembly part and the second assembly part.

### CROSS-REFERENCE TO RELATED APPLICATION

This application claims the priority benefit of Taiwan application serial no. 96138850, filed on Oct. 17, 2007. The entirety of the above-mentioned patent application is hereby incorporated by reference herein and made a part of this specification.

### BACKGROUND OF THE INVENTION

1. Field of the Invention

The present invention relates to a flexible speaker and products designed through using the speaker. More particularly, the present invention relates to a speaker box, which can selectively form a three-dimensional shape with an inner space for generating resonance to enhance the intensity and depth of a sound field when the flexible speaker produces sounds.

2. Description of Related Art

Among human-being's five senses, auditory sensation and visible sensation are pivots for the civilization progress, and the auditory sensation is more important. The auditory sensation is provided for hearing sounds, so the spreading of sounds has become one of the key points in human society.

Sound of the nature comes from all directions. This is the natural sensation world, the most complete and the most multi-directional sound source, and it is also the world that human-beings try to simulate after they are capable of catching the sound, storing the sound, reproducing the sound, and delivering the sound. Therefore, the design diversity of the speaker for reproducing sounds has become an important technical topic.

For example, currently, it is an topic in the sound engineering about how to make the sound emitted from the speaker have a high fidelity and satisfy the current demands for light, thin, short, and small. In common audio-visual room, two speakers are not enough, in order to increase sound sources, several additional speakers are further added on left and right sides of the back part. However, lightness of the sound-spreading medium is also an factor considered by consumers. Due to the restrictions in technique, material, and relevant concepts, although the speaker has been significantly improved in terms of adjusting the size and weight, it is still limited by the definitions of “device”, “three-dimensional space”, and “fixed-points”, that is, the speaker is considered as a “device”, a equipment with a “three-dimensional space”, and is “fixed at certain point”.

It is one of the issues in this field that how to make the speaker break out of the restrictions of concept, material, and technique, so as to cater to the requirements of being lighter, more convenient, more versatile, and more individualized in the current and further world.

### SUMMARY OF THE INVENTION

Accordingly, the present invention is directed to a speaker box, including a flexible speaker and a housing. The flexible speaker includes an electret vibrating-film layer. The housing includes a first assembly part and a second assembly part, which may be combined into a three-dimensional shape by a combining device, and a resonance space is formed therein. When the first assembly part and the second assembly part are not combined by the combining device, the first assembly part and the second assembly part are in flat shape. When the first assembly part and the second assembly part are combined into the three-dimensional shape through the combining device, the electret vibrating-film layer of the flexible speaker is at least located on an external side of the first assembly part or on an external side of the second assembly part.

In the speaker box, the box body is made of a soft material, for example, textile, or cloth.

In the speaker box, the combining device is a zipper device, in which the first joining portion and the second joining portion are combined upon being applied with an external force.

In the speaker box, the flexible speaker further includes a sound-source receiving unit and a conductive electrode. The sound-source receiving unit is used to receive an external sound source signal, and to convert the sound source signal into a potential signal. The conductive electrode is used for connecting the sound-source receiving unit to the electret vibrating-film layer, transmitting the potential signal to the electret vibrating-film layer, and producing sounds accordingly.

In another alternative embodiment, the flexible speaker further includes an input port and a conductive electrode. The input port is used to receive an external potential signal. The conductive electrode is used for connecting the input port to the electret vibrating-film layer, transmitting the potential signal to the electret vibrating-film layer, and producing sounds accordingly.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic three-dimensional view of a speaker box according to an embodiment of the present invention when being unfolded.

FIG. 1B is a schematic three-dimensional view of the speaker box according to the embodiment of the present invention when being folded to form a three-dimensional shape.

FIG. 1C shows a shape of the speaker box according to the embodiment of the present invention after being flatly unfolded.

FIG. 2A shows a structure of a flexible speaker according to an embodiment of the present invention.

FIG. 2B shows a structure of a flexible speaker according to another embodiment of the present invention.

### DESCRIPTION OF EMBODIMENTS

The present invention provides a speaker box having a flexible speaker with a flat structure and fixed on at least one or more surfaces of a body made of a soft material. When the speaker box is not used, the box made of soft material may be flatly unfolded, so as to minimize the occupied accommodation space. However, when it is used, a combining device, for example a zipper, in the body made of soft material is used to connect different surfaces of the body to form the three-dimensional shape. The inner part is provided for generating resonance to enhance the intensity and depth of the sound field, when the flexible speaker produces sounds.

The flexible speaker is formed by a sound-source receiving unit, a conductive electrode, and an electret vibrating-film layer. The sound-source receiving unit is connected to the electret vibrating-film layer through the conductive electrode and used for receiving an external sound source signal, converting the sound source signal into a potential signal, and then transmitting the potential signal to the electret vibrating-film layer through the conductive electrode. The electret vibrating-film layer may be made of a dielectric material. The dielectric material is capable of maintaining electrostatic charges for a long time after being electrized, and generating ferroelectric effect therein upon being charged. The electret vibrating-film layer may be a vibrating film made of a single-layered or multi-layered dielectric material, and the dielectric material may be, for example, fluorinated ethylenepropylene copolymer (FEP), polytetrafluoroethylene (PTFE), polyvinylidene fluride (PVDF), some Fluorine Polymer, and other suitable materials. The electret vibrating film is a vibrating film that is capable of maintaining the electrostatic charges and piezoelectricity for a long time after the dielectric material is electrized, and thus, and thus, upon being corona charged, dipolar charges are generated within the material, so as to generate the ferroelectric effect. The sound source signal is converted into the potential signal, and transmitted to the electret vibrating-film layer through the conductive electrode to produce sounds accordingly. Different voltage values of the potential signal may enable the electrets to generate sounds with different frequencies.

In another alternative embodiment, the flexible speaker is formed by an input port, a conductive electrode, and an electret vibrating-film layer. An external sound-source receiving unit converts the sound source signal into a potential signal, and then transmits the potential signal to the conductive electrode through the input port, and the potential signal is directly transmitted to the electret vibrating-film layer to produce sounds.

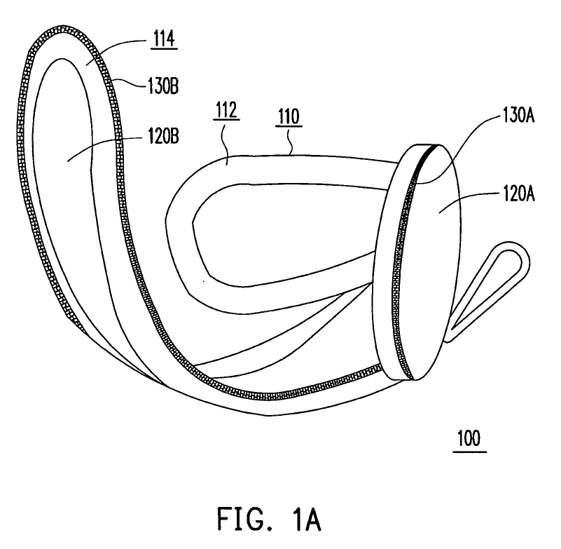

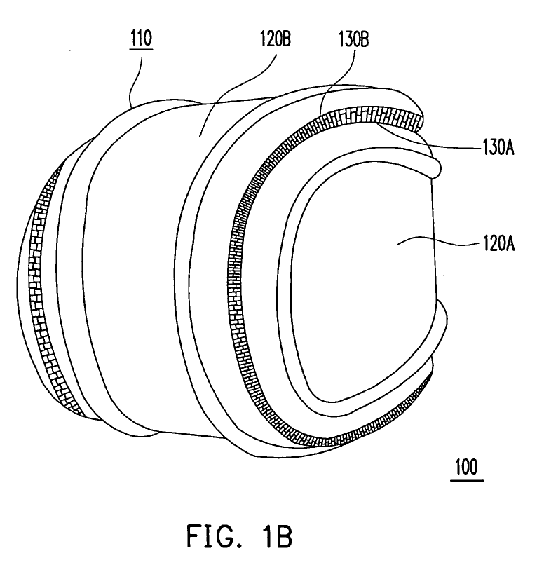

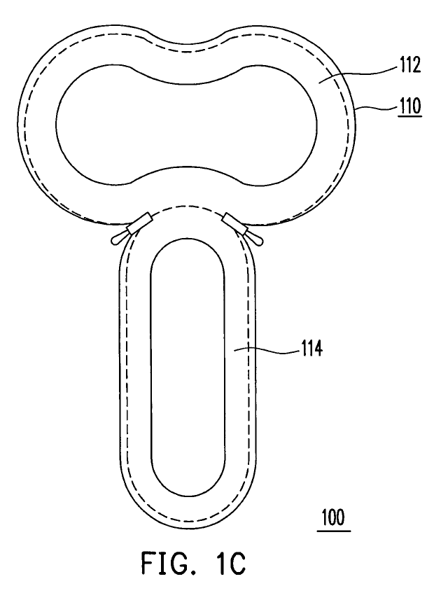

Referring to FIGS. 1A to 1C, they are mainly schematic views of a speaker box according to an embodiment of the present invention. FIG. 1A is a schematic three-dimensional view of a speaker box according to an embodiment of the present invention when being unfolded, FIG. 1B is a schematic three-dimensional view of the speaker box according to the embodiment of the present invention when being folded into a three-dimensional shape, and FIG. 1C shows a shape of the speaker box after being flatly unfolded.

Referring to FIG. 1A, in one embodiment, a speaker box 100 includes a housing and a flexible speaker having two electret vibrating-film layers 120A and 120B. The housing, for example, a box body 110, is made of a soft material, for example textile, or cloth. The flexible speaker includes, for example, a sound-source receiving unit, a conductive electrode, and an electret vibrating-film layer. However, for the convenience of illustration, merely the electret vibrating-film layers 120A and 120B fixed on external sides of the box body 110 are shown. The detailed structure of the flexible speaker is described later. FIG. 1B is a schematic three-dimensional view of the speaker box after being folded into the three-dimensional shape. That is, when it is being used, the box body 110 is formed into the three-dimensional shape, and the inner part is provided for generating resonance to enhance the intensity and the depth of the sound field when the flexible speaker produces sounds.

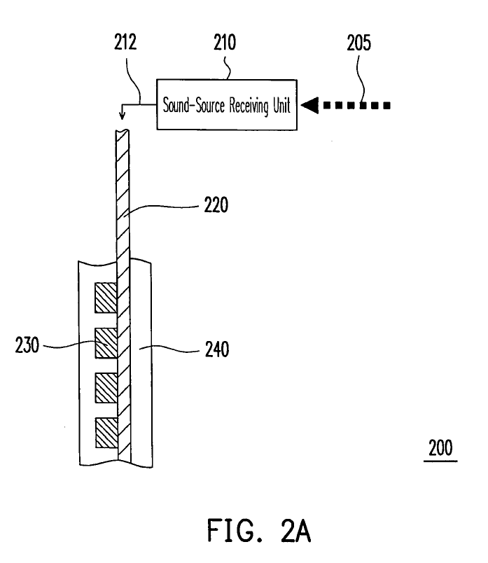

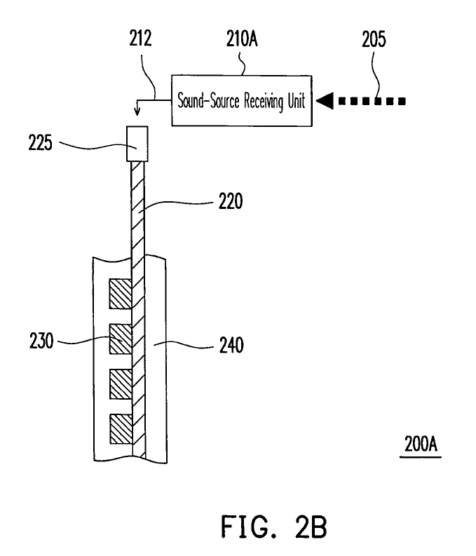

The box body 110 includes two assembly parts 112 and 114 partially connected with each other, and the two assembly parts 112 and 114 respectively have two joining portions 130A and 130B that are combined through a zipper. When the speaker box 110 needs to be fixed into the three-dimensional shape, the two joining portions 130A and 130B are used for combination, so as to fix the two assembly parts 112 and 114 together. When the speaker box 110 is not used, as shown in FIG. 1C, the assembly parts 112 and 114 are partially connected with each other, such that the assembly parts 112 and 114 of the whole speaker box 110 can be flatly unfolded, which is convenient for being carried along. The electret vibrating-film layers 120A and 120B are respectively located on external sides of the assembly parts 112 and 114. Referring to FIG. 2A, the construction of the flexible speaker is illustrated. The flexible speaker 200 is formed by a sound-source receiving unit 210, a conductive electrode 220, and an electret vibrating-film layer 230, and it is embedded into a soft material layer 240, for example, the box body made of soft material shown in FIG. 1. The sound-source receiving unit 210 is connected to the electret vibrating-film layer 230 through the conductive electrode 220, and used for receiving an external sound source signal 205, converting the sound source signal 205 into a potential signal 212, and then transmitting the potential signal 212 to the electret vibrating-film layer 230 through the conductive electrode 220. The electret vibrating-film layer 230 is a vibrating film that is capable of maintaining the electrostatic charges and the piezoelectricity after being electrized, and thus, upon being corona charged, dipolar charges are generated within the material, so as to generate the ferroelectric effect. The sound source signal 205 is converted into the potential signal 212, and transmitted to the electret vibrating-film layer 230 through the conductive electrode 220 for producing sounds. Different voltage values of the potential signal 212 may enable the electrets to generate sounds with different frequencies.

Referring to FIG. 2B, it shows a structure of a flexible speaker according to another embodiment of the present invention. The difference from FIG. 2A lies in that the flexible speaker 200A includes an input port 225. The sound-source receiving unit 210A is an external device, and it is not disposed within the flexible speaker 200A. The external sound-source receiving unit 210A converts the sound source signal 205 into the potential signal 212, and transmits the potential signal 212 to the conductive electrode 220 through the input port 225, and then, the potential signal 212 is directly transmitted to the electret vibrating-film layer 230 for producing sounds.

To sum up, the present invention provides a speaker box having a flexible speaker with a flat structure and fixed on at least one or more surfaces of the body made of soft material. When the speaker box is not used, the box made of soft material can be flatly unfolded, so as to minimize the accommodating space. However, when it is used, a combining fixing device, for example a zipper, in the body made of soft material is used to connect different surfaces of the body into the three-dimensional shape. The three-dimensional shape may be a regular cubic shape formed by the two pieces in the above embodiment, or a triangular cubic shape formed by a plurality of pieces. The inner box is provided for generating resonance to enhance the intensity and depth of the sound field, when the flexible speaker produces sounds.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A speaker box, comprising:
a flexible speaker, having at least an electret vibrating-film layer; and
a housing, made of a soft material, the housing having a first assembly part and a second assembly part, wherein the first assembly part and the second assembly part are partially connected with each other, unconnected parts for the first assembly part and the second assembly part are combined into a three-dimensional shape by a combining device and a resonance space is formed therein, wherein when the first assembly part and the second assembly part are combined into the three-dimensional shape by the combining device, the electret vibrating-film layer of the flexible speaker is at least located on an external side of the first assembly part or the second assembly part, or on external sides of the first assembly part and the second assembly part.

2. The speaker box as claimed in claim 1, wherein the three-dimensional shape formed by combining the first assembly part and the second assembly part through the combining device is a regular cubic shape.

3. The speaker box as claimed in claim 1, wherein the soft materials is a textile or cloth.

4. The speaker box as claimed in claim 1, wherein the combining device is a zipper device, comprising a first joining portion and a second joining portion respectively located on a side surface of the first assembly part and a side surface of the second assembly part, for combining the first joining portion with the second joining portion.

5. The speaker box as claimed in claim 1, wherein the electret vibrating-film layer is made of a dielectric material, and the dielectric material is capable of maintaining electrostatic charges for a long time after being electrized and generating ferroelectric effect within the material upon being charged.

6. The speaker box as claimed in claim 1, wherein the flexible speaker further comprises:
a sound-source receiving unit, for receiving an external sound source signal, and converting the sound source signal to a potential signal; and
a conductive electrode, for connecting the sound-source receiving unit and the electret vibrating-film layer, transmitting the potential signal to the electret vibrating-film layer, and producing sounds accordingly.

7. The speaker box as claimed in claim 1, wherein the flexible speaker comprises:
an input port, for receiving an external potential signal; and
a conductive electrode, for connecting the input port and the electret vibrating-film layer, transmitting the potential signal to the electret vibrating-film layer, and producing sounds accordingly.
